(19) United States
(12) Patent Application Publication
(10) Pub. No.: US 2004/0146282 A1
(43) Pub. Date: Jul. 29, 2004

(54) Method for displaying information of data to be deleted in digital video recorder

(75) Inventor: Young Wook Lee, Seoul (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/757,478

(22) Filed: Jan. 15, 2004

(30) Foreign Application Priority Data
Jan. 16, 2003 (KR) 10-2003-0003006

(51) Int. Cl. H04N 5/76; H04N 5/225

(52) U.S. Cl. 386/95; 386/117

(57) ABSTRACT

Method and apparatus for displaying information of data to be deleted in a digital video recorder are configured to read management information (e.g., recording date and time) of data to be deleted from a hard disk (HDD) when it is required to overwrite data on the HDD. Data overwriting can occur because of insufficient spare space of the HDD, during the recording operation of a digital video recorder. The read management information can be displayed along with the recording status of the HDD. Accordingly, a user can recognize, in advance, the data to be deleted in accordance with the data overwriting operation, and thus, selectively back up the data to be deleted.

### BACKGROUND OF THE INVENTION

1. Field of the Invention

The present invention relates to a digital video recorder and a method of operating the same.

2. Background of the Related Art

A Digital video recorder (DVR) can be adapted to simultaneously monitor several areas. Such a DVR includes a hard disk (HDD) used as a main storage medium to store a large quantity of video or audio data, and a disc driver, such as compact disk-rewritable (CD-RW), used as an auxiliary storage medium adapted to back up the data stored in the main storage medium.

As shown in FIG. 1, a related art DVR is illustrated. As shown in FIG. 1, a DVR 300 is connected to a plurality of monitoring cameras 10₁ to 10ₙ respectively located at dispersed areas to be monitored and a plurality of monitoring sensors 20₁ to 20ₖ. The DVR 300 may be connected, via a network 400, to a computer 500 operated by a system operator at a remote place.

The DVR 300 detects a variation in a video signal outputted from each monitoring camera in accordance with an image pickup operation of the monitoring camera. When the detected video signal variation exceeds a predetermined variation, or when a signal indicating a occurrence of something is received from any one of the monitoring sensors, the DVR 300 determines that an event such as invasion by a third party has occurred. Where it is determined that such an event has occurred, as shown in FIG. 2 the DVR 300 records on its HDD the video signal outputted from the monitoring camera installed at the area associated with the determined or detected event.

When the event is released or the associated video signal, which is recorded on the HDD while maintaining a time continuity, reaches a predetermined data size (e.g., 40 Mbytes) during the recording operation for the video signal, the DVR 300 manages the recorded event video data as a separate data file. For this management, the DVR 300 also additionally records a recording date and time of the data file.

The DVR 300 may display the recording status of the HDD in the form of a histogram and a percentage (%) using an on-screen display (OSD) image. For example, where the used space of the HDD corresponds to 30% or 100% of the capacity of the HDD, as shown in FIG. 3, the corresponding histogram and percentage are respectively displayed in the form of an OSD image.

Accordingly, the system operator can identify the current situation of each area by monitoring the video images transmitted, in real time, from the DVR 300, or can identify previous events and invaders from data files stored in the HDD. Also, the system operator can identify the spare space of the HDD, which remains capable of recording additional data, by referring to the displayed OSD image.

However, the related art DVRs and methods for using same have various disadvantages. When it is required to delete data recorded on an HDD during the recording operation of the related art digital video recorder or to overwrite new data on the HDD due to an insufficient spare space of the HDD, no information to inform the system operator of the data to be deleted is available. For this reason, there is a problem in that important data recorded on the HDD may be unintentionally deleted when new data is overwritten.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the invention is to provide a method and apparatus for displaying information of data to be deleted in a digital video recorder during a data recording operation.

Another object of the invention is to provide a method and apparatus for displaying information of data to be deleted in a digital video recorder during a data recording operation because of insufficient storage space of the DVR.

Another object of the invention is to provide a method and apparatus for displaying information of data to be deleted in a digital video recorder during a data recording operation whereby management information of the data to be deleted can allow the user to identify information of the data to be deleted so as to back up the data stored in the DVR in accordance with the result of the identification.

Another object of the invention is to provide a method and apparatus for displaying information of data to be deleted in a digital video recorder during a data recording operation which is adapted to display, in the form of an OSD image, management information of data to be deleted from a hard disk (HDD) when it is required to overwrite data on the HDD during the recording operation of a digital video recorder.

To achieve at least these and other advantages in a whole or in part and in accordance with the purpose of the present invention, as embodied and broadly described herein, there is provided a method for displaying information of data, to be deleted, in a digital video recorder that includes reading management information of data to be deleted in accordance with a data overwriting operation during a recording operation performed by the digital video recorder, and displaying the read management information.

To further achieve at least these and other advantages in a whole or in part and in accordance with the purpose of the present invention, as embodied and broadly described herein, there is provided a digital video recorder that includes a circuit for reading management information of data to be deleted in accordance with a data overwriting operation during a recording operation performed by the digital video recorder, and a circuit for displaying the read management information.

To further achieve at least these and other advantages in a whole or in part and in accordance with the purpose of the present invention, as embodied and broadly described herein, there is provided a method of operating a digital video recorder that includes recording current data from at least one of a plurality of sensors, storing the current recorded data to a first location of a storage device of the digital video recorder, reading management data of a file to be deleted from the storage device responsive to a data overwrite operation, displaying the read data management information to a user, and selectively storing the file to be deleted to an additional storage device in accordance with an operation by the user responsive to the displayed read management data.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating a related art digital video recorder (DVR) connected to a plurality of monitoring cameras, a plurality of monitoring sensors, and an operator's computer;

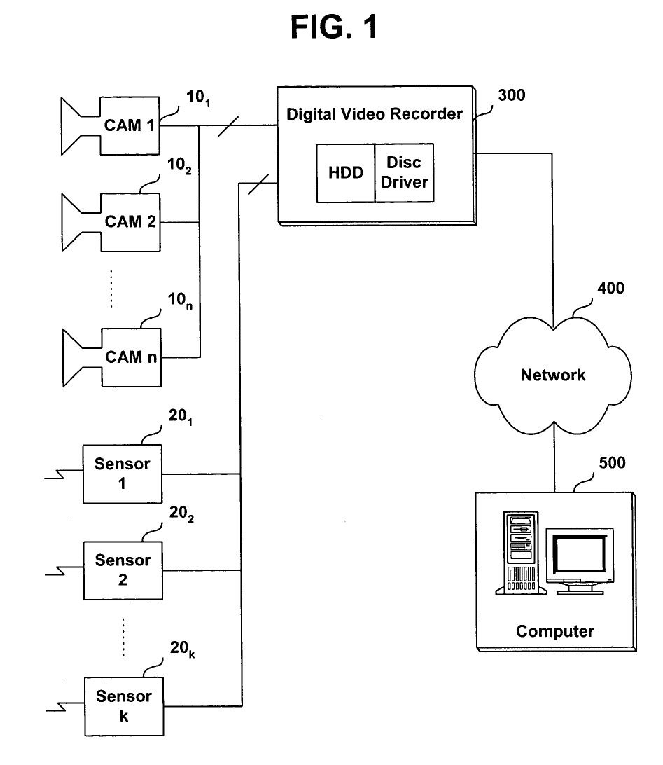

FIG. 2 is a schematic view illustrating a data file recording procedure carried out in a related art DVR;

FIG. 3 is a schematic view illustrating an OSD image displayed by a related art DVR to represent the recording status of a hard disk (HDD);

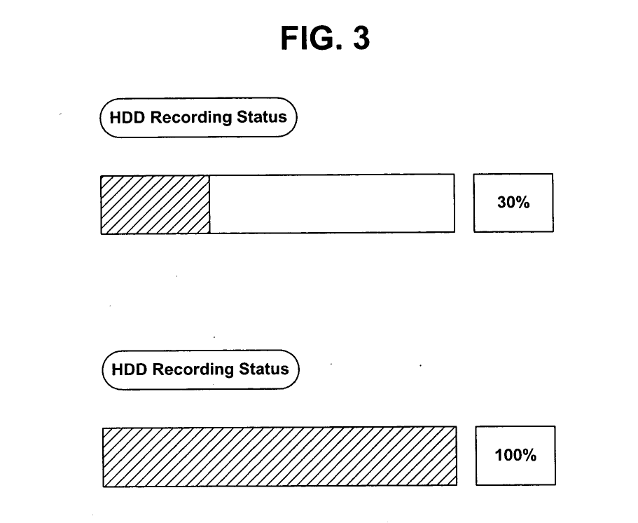

FIG. 4(a) is a diagram illustrating an exemplary position at which a recording operation is being carried out and a position of data of which management information is read, on an HDD in a DVR according to embodiments of the present invention;

FIG. 4(b) is a diagram illustrating an exemplary OSD image for recording status of an HDD displayed by a DVR according to embodiments of the present invention; and

FIG. 5 is flow chart illustrating a method for displaying information of data, to be deleted, in the DVR in accordance with the present invention.

### DETAILED DESCRIPTION OF PREFERRED EMBODIMENTS

A digital video recorder (DVR) can record on a hard disk (HDD) or the like, a video signal received from a monitoring camera in accordance with one of various image pickup operations of the monitoring camera installed in an area. For example, the DVR can record the video signal from the monitoring camera in a continuous manner, every time a variation is sensed by the monitoring camera, in accordance with a monitoring sensor installed in the area or the like. Alternatively, the DVR may record a video signal in a continuous manner during the daytime, while recording a video signal every time a variation in the area is sensed in the evening or on a holiday.

When a video signal transmitted from a monitoring camera in accordance with an image pickup operation of the monitoring camera is recorded on an HDD in a continuous manner, there is a possibility that new data has to be overwritten on the HDD because the HDD has an insufficient spare space to record the data thereon. In this case, therefore, it can be necessary to simultaneously perform the operation of recording a video signal and the operation of backing up data to be deleted in accordance with a data overwriting operation.

On the other hand, where the video signal is not recorded in a continuous manner, but recorded every time a variation in an area is sensed, it can be unnecessary to simultaneously perform the recording operation and the backup operation. That is, the backup operation can be carried out for the data to be deleted in accordance with the data overwriting operation when no video signal is recorded. However, even in this case, it is difficult or impossible to estimate the time when a situation requiring recording of a video signal occurs. If such a situation occurs during the backup operation, it is difficult or impossible to store complete backup data. Accordingly, even in this case, it is desirable, in terms of security, to configure the system that can simultaneously perform the recording operation and the backup operation.

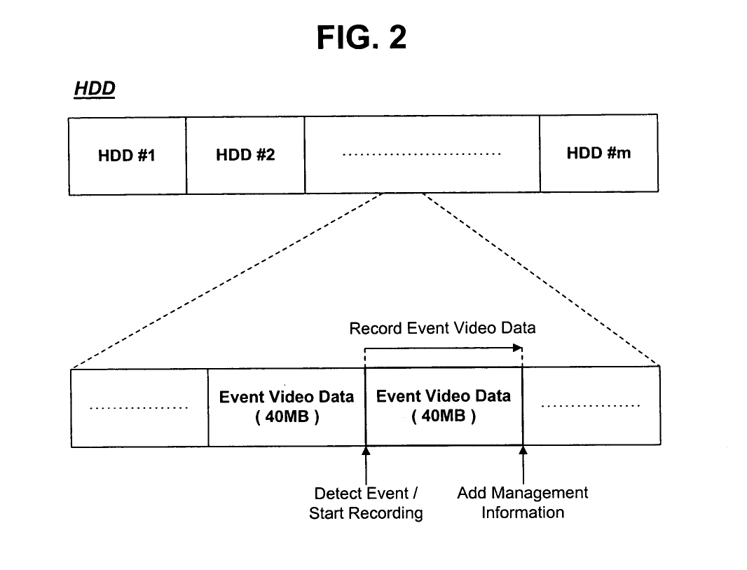

In order to simultaneously perform the recording operation and the backup operation while recording a large quantity of video signals, the DVR may include a plurality of HDDs (e.g., HDD #1 to HDD #m) adapted to record video signals, as shown in FIG. 2. In accordance with such a configuration, there is an advantage in that the recording operation and backup operation can be simultaneously carried out on different HDDs, respectively.

In accordance with embodiments of methods and apparatus according to the present invention for displaying information of data, which is to be deleted in such a DVR, the recording operation of video data and a display operation for management information of data to be deleted in accordance with a data overwriting operation and the selective backup operation for the data are simultaneously executed. In order to achieve the simultaneous execution, the recording operation, and the display and selective backup operation can be carried out at different HDD positions, respectively.

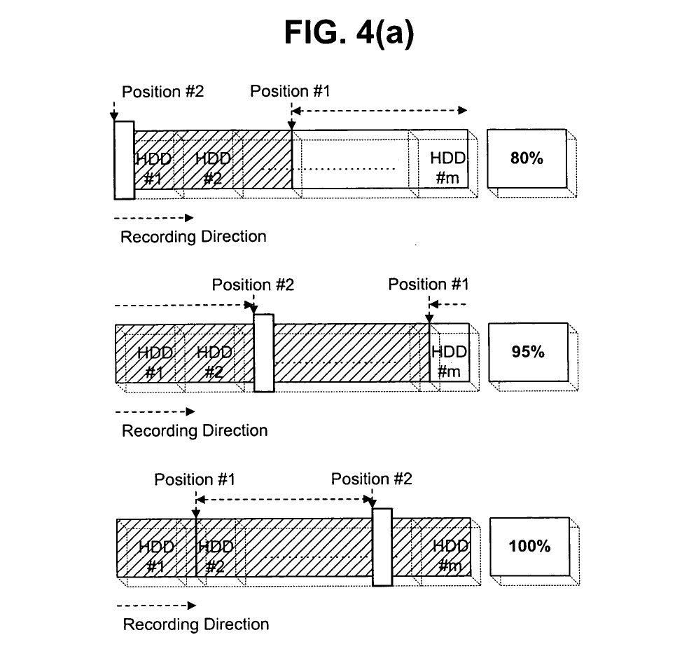

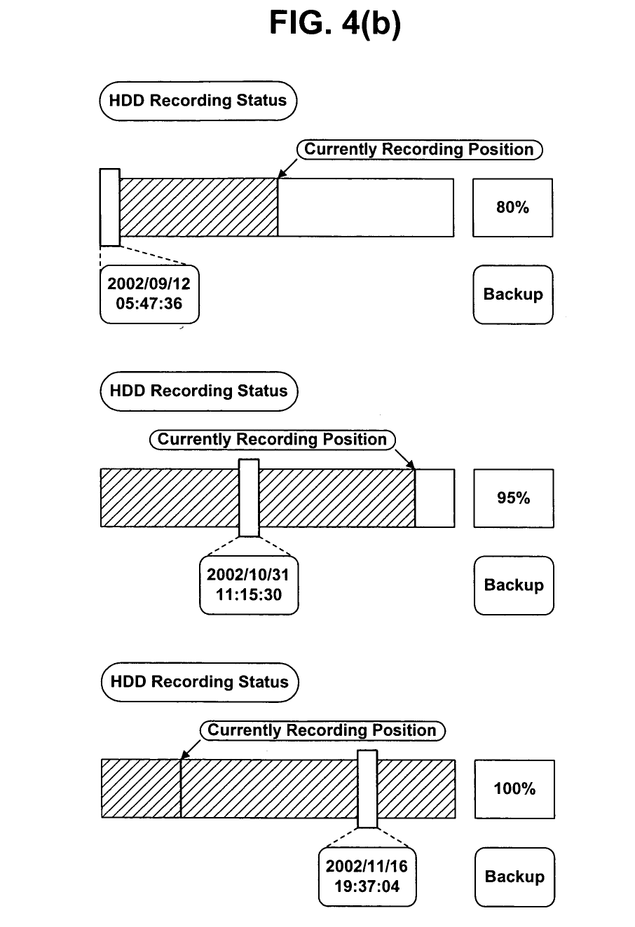

FIG. 4(a) is a diagram illustrating an exemplary position at which a recording operation is being carried out and an exemplary position of data where management information is being read, on an HDD in a DVR according to embodiments of the present invention. FIG. 4(b) is a diagram illustrating an exemplary recording status OSD image of an HDD displayed by a DVR according to embodiments of the present invention. For example, as shown in FIG. 4(a) or 4(b), when a recording operation is carried out at an HDD position Position #1, reading and displaying operations for management information of data recorded on the HDD are carried out at an HDD position Position #2 spaced apart from the HDD position Position #1 by a predetermined distance. Based on the read management information, a backup operation can also be performed for the data recorded at the HDD position Position #2. In accordance with this example, where it is required to overwrite data because of an insufficient spare space of the HDD, the data recorded on the HDD is preferentially backed up at a position separated from or preceding (e.g., by the predetermined distance) the position of data being currently deleted by the overwriting operation.

As shown in FIGS. 4(a) and 4(b), it is assumed that the distance between the positions Position #1 and Position #2 corresponds to 20% of the entire HDD space. However, the present invention is not intended to be so limited as other values or percentages may be used as the predetermined distance. The uppermost illustration in FIG. 4(a) or FIG. 4(b) shows the recording status of the HDD having data recorded on the HDD occupy 80% of the entire HDD space. In this recording status, the position preceding the 80% HDD position by 20% preferably corresponds to the last position of the HDD. However, since the recording operation on the HDD proceeds in a direction from left to right, the last HDD position overlaps with the first position of the HDD. Accordingly, a first HDD position corresponds to the HDD position Position #2. That is, a reading operation for management information of data recorded on the HDD and a backup operation for the data, based upon the read management information, can be carried out at the first HDD position.

The intermediate illustration in FIG. 4(a) or FIG. 4(b) shows the recording status of the HDD where data recorded on the HDD occupies 95% of the entire HDD space. In this status, the HDD position spaced apart from the first HDD position by a distance corresponding to 15% corresponds to the HDD position Position #2 at which the management information reading operation and backup operation are preferably to be carried out.

The lowermost illustration in FIG. 4(a) or FIG. 4(b) shows the recording status of the HDD that the HDD has substantially no spare space. In this status, data overwriting must be carried out at an HDD position where data has already been recorded, because there is no spare space capable of additionally recording new data on the HDD. Since the recording operation on the HDD proceeds in a direction from left to right, the management information displaying operation and the backup operation are preferably carried out for the data recorded at the HDD position Position #2 spaced apart from the currently recording HDD position Position #1 by 20% in a right direction.

Preferably, a distance between the HDD positions Position #1 and Position #2 is set in accordance with the specification of the system and an appropriate selection by a user operating the DVR according to embodiments of the present invention. In place of a single HDD, a plurality of HDDs each having a smaller capacity may be used in a DVR. In this case, the distance between the HDD positions Position #1 and Position #2 can be set such that the HDD positions Position #1 and Position #2 are not positioned on the same HDD.

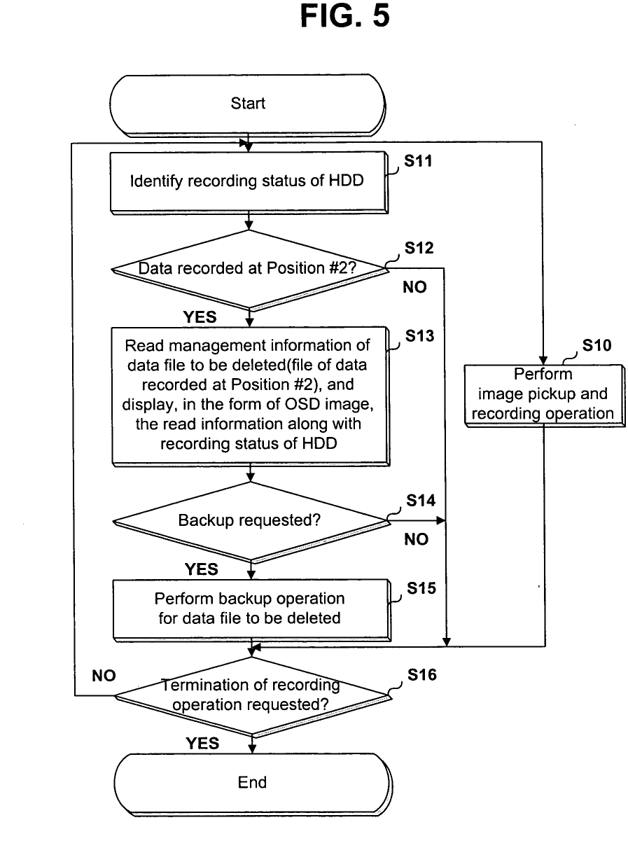

FIG. 5 is a flow chart illustrating an embodiment of a method for displaying information of data that is to be deleted in a DVR in accordance with the present invention. The method shown in FIG. 5 can be applied to and will be described referencing exemplary DVRs as shown in FIG. 4. However, the present invention is not intended to be so limited.

In accordance with the embodiment of the method for managing information that is to be deleted in a DVR, a DVR performs an operation of recording a video image associated with an event on an HDD (block S10). The DVR preferably detects respective variations in video images picked up by monitoring cameras or the like installed in dispersed areas, and determines that the event such as invasion by a third party occurred, when the video image variation detected in association with one of the areas exceeds a predetermined reference variation. Of course, all video images or video signals may be recorded in a continuous manner and/or intermittent manner by the DVR. The video signal recording operation is preferably carried out simultaneously with operations of displaying information of data to be deleted, and of selectively backing up the data to be deleted.

Further, the DVR 300 continuously identifies the recording status of the HDD on which video data is recorded (block S11). Information of the recording status of the HDD can include a current recording position of video data, and the HDD status such as the rate of the spare space to the entire space in the HDD. The current recording position is preferably designated, for example, by “Position #1” as shown in FIG. 4(a).

Also, the DVR identifies whether there is data recorded at a position (e.g., the position Position #2) spaced apart from the currently recording position (e.g., Position #1) by a predetermined distance (block S12). Where it is determined based on the result of the identification that there is data recorded at the position where the recorded data is to be deleted (e.g., Position #2), the DVR reads management information of the recorded data because the recorded data is to be subsequently deleted (block S13). Thereafter, the DVR 300 displays, preferably in the form of an OSD image or the like, the read management information, which may include recording date and recording time, the current recording position and the identified HDD status (block S11), a mark representing the position Position #2 of the data or data file to be subsequently deleted in accordance with an overwriting operation for new data and the like (block S13).

A backup option button may also be displayed on the OSD image, for example as shown in FIG. 4(b). The backup menu button is adapted to allow the user to select a backup operation for recording the data file, which is to be deleted, on another recording medium such as a rewritable optical disc (block S14). When the user selects the backup option button (block S14), the DVR backs up the data file to be deleted that was recorded at the position Position #2 (block S15). The backup option operation can be a prescribed operation, operations in accordance with user instructions or the like. Preferably, blocks S10 and S11 to S15 are repeatedly executed until the user requests termination of the recording operation (block S16).

Exemplary OSD images are shown in FIG. 4(a) and FIG. 4(b). However, the present invention is not intended to be so limited. According to embodiments of the present invention, the OSD image may also include more diverse graphs and guidance information. The OSD image can be a different display capability. Also, the data file to be deleted may be transferred to an external backup device so that it is subsequently downloaded.

As described above, embodiments of methods and apparatus for displaying information of data, to be deleted, in a digital video recorder according to the present invention have various advantages. Embodiments of the present invention provides a method for displaying information of data, to be deleted, in a digital video recorder, which enables the user to recognize, in advance, data to be deleted in accordance with a data overwriting operation, and thus, to back up the data as desired. Accordingly, embodiments of the present invention are capable of efficiently reducing or preventing important data from being unintentionally deleted in accordance with data overwriting operations.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for displaying information of data, to be deleted, in a digital video recorder, comprising:
reading management information of data to be deleted in accordance with a data overwriting operation during a recording operation performed by the digital video recorder; and
displaying the read management information.

2. The method of claim 1, wherein the read management information is displayed in the form of an on-screen display (OSD) image.

3. The method of claim 2, wherein the OSD image includes a recording date and time for a file of the data to be deleted in accordance with the data overwriting operation, and a mark identifying a position of the data file to be deleted.

4. The method of claim 3, wherein the OSD image includes a mark identifying a position of video image data being currently recorded in the recording operation.

5. The method of claim 1, wherein the recording operation comprises:
processing a video image picked up by at least one monitoring camera;
detecting a variation in the video image to determine whether a particular event has occurred; and
recording data of the video image on a main storage medium of the digital video recorder when the variation is detected.

6. The method of claim 5, wherein the data overwriting operation is executed in a sequential manner, starting from a position at which the oldest one of the data recorded on the main storage medium is recorded, and wherein the data overwriting operation is executed when there is substantially no spare space on the main storage medium for additional recording data.

7. The method of claim 1, wherein the management information includes recording date information or recording time information of a file of the data to be deleted.

8. The method of claim 7, wherein the management information is information of the data file recorded on the main storage medium at a position spaced apart by a predetermined distance from a current recording position of the main storage medium.

9. The method of claim 8, wherein the predetermined distance corresponds to a distance between the current recording position and the management information read position is determined by at least one of a control signal, a predetermined distance and a selection made by a user.

10. The method of claim 7, wherein the management information is information of the data file recorded on the main storage medium separated by a predetermined amount of data from a current recording position of the main storage medium.

11. The method of claim 1, comprising backing up a file of the data, to be deleted, on a backup recording medium.

12. The method of claim 11, wherein the backup recording medium is external to the digital video recorder.

13. The method of claim 11, wherein the data backup is executed for a subset of the data files to be deleted.

14. The method of claim 11, wherein an OSD image includes a backup option button for selecting a backup operation for the data file to be deleted.

15. A digital video recorder, comprising:
means for reading management information of data to be deleted in accordance with a data overwriting operation during a recording operation performed by the digital video recorder; and
means for displaying the read management information.

16. The digital video recorder of claim 15, wherein the management information includes recording date information or recording time information of a file of the data to be deleted, wherein the management information is information of the data file recorded on the main storage medium at a position spaced apart from a current recording position of the main storage medium by a predetermined distance or separated from the current recording position of the main storage medium by a predetermined amount of data.

17. The digital video recorder of claim 16, comprising:
means for storing the file of the data to be deleted, on a backup recording medium.

18. The digital video recorder of claim 17, wherein the means for displaying comprises an on-screen display (OSD), wherein an OSD image includes a recording date and time for the file of the data to be deleted in accordance with the data overwriting operation, and a mark identifying the position of the data file to be deleted, wherein the OSD image includes a mark identifying the position of video image data being currently recorded in the recording operation, and wherein the OSD image includes a backup option button for selecting a backup operation for the data file to be deleted.

19. A method of operating a digital video recorder, comprising:
recording current data from at least one of a plurality of sensors;
storing the current recorded data to a first location of a storage device of the digital video recorder;
reading management data of a file to be deleted from the storage device responsive to a data overwrite operation;
displaying the read data management information to a user; and
selectively storing the file to be deleted to an additional storage device in accordance with an operation by the user responsive to the displayed read management data.

20. The method of claim 19, wherein the additional storage device is external to the digital video recorder, and wherein the data file to be deleted is recorded on the storage device separated from the first recording position of the main storage medium by a predetermined amount of data.
